(19) United States
(12) Patent Application Publication
(10) Pub. No.: US 2025/0342482 A1
(43) Pub. Date: Nov. 6, 2025

(54) SYSTEM AND METHOD FOR EVENT MANAGEMENT WITH ERROR IDENTIFICATION AND REMEDIATION

(71) Applicant: Reveer, LLC, Mundelein, IL (US)

(72) Inventor: Colleen Passolt, Mundelein, IL (US)

(21) Appl. No.: 19/196,650

(22) Filed: May 1, 2025

Related U.S. Application Data
(60) Provisional application No. 63/642,522, filed on May 3, 2024.

(51) Int. Cl. G06Q 30/016

(52) U.S. Cl. CPC G06Q 30/016

(57) ABSTRACT

A method for event management is disclosed that includes requesting information regarding CRM events, wherein the event-associated data and rules designate required actions in response to the CRM events, matching the event-associated data and rules to the CRM events; identifying any errors involving discrepancies that exist between CRM events that were expected and that have occurred, the matched event-associated data and rules corresponding to the CRM events that were expected and that have occurred, and the required actions in response to the CRM events that were expected and that have occurred; and initiating remedial actions to correct the identified errors involving discrepancies that exist between CRM events that were expected and that have occurred, the matched event-associated data and rules corresponding to the CRM events that were expected and that have occurred, and the required actions in response to the CRM events that were expected and that have occurred.

### TECHNICAL FIELD

The present application pertains to error identification and remediation, and more particularly, to a system and method for event management with error identification and remediation through multiple interacting systems.

### BACKGROUND

### Description of the Related Art

Before the wide adoption of the Internet, there were many types of events, orders, deals, and the like that needed to be tracked by hand. These types of events, orders, and deals needed to be tracked because there were often information and rules that needed to be associated with those events, orders, and deals. Some such information and rules were commissions or other types of required actions in response to the information and rules. When the Internet became more widely accepted, many companies, both large and small, started to track this information over the Internet. However, this use of computer methods and the Internet created many problems that did not previously exist when these matters were tracked by hand.

Thus, there were new shortcomings that arose as well from these computer methods. For example, computer methods were effective at recording what was supposed to happen, but were not effective at recording what actually happened. In this manner, there were many types of events, orders, and deals that were supposed to have associated information and rules (e.g., commissions) that were supposed to result in one or more actions, (e.g., payments, credits, or other actions), but these actions would not occur for any of a variety of reasons. For example, rules would not be followed, payments/credits would not be made, connections between deals and operators would be lost, and the like. Additionally, these computer methods would not provide any methodology for identifying these shortcomings.

As a result, many of these legacy computer methods were undesirable and potentially less useful than previous hand-based tracking. Currently, there is no technological solution for such deficiencies and shortcoming of computer-based tracking methods. Furthermore, there is a continuing desire to provide effective computer-based tracking of events and associated rules. The present disclosure addresses this and other needs.

### BRIEF SUMMARY

Briefly stated, embodiments of the present disclosure are directed towards an event management method for identifying and remediating errors involving discrepancies related to Customer Relationship Management (CRM) events. The method includes: accessing CRM events, via an event management system, from a payment source data system; loading event-associated data and rules via the event management system that correspond to the CRM events, wherein the event-associated data and rules designate required actions in response to the CRM events; matching the event-associated data and rules to the CRM events; identifying any errors involving discrepancies that exist between the CRM events that were expected and that have occurred, the matched event-associated data and rules corresponding to the CRM events that were expected and that have occurred, and the required actions in response to the CRM events that were expected and that have occurred; and initiating remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.

In some embodiments, the event management method further comprises: after matching the event-associated data and rules to the CRM events, populating an audit interface comparing expected required actions in response to the CRM events against actual performed required actions in response to the CRM events. In another aspect of some embodiments, the event management method further comprises: after identifying any errors involving discrepancies, creating a flag to initiate remedial actions to correct the identified errors. In still another aspect of some embodiments, the event management method further comprises: submitting a remedial action request to a responsible payor system to resolve the error. In yet another aspect of some embodiments, the event management method further comprises: after matching the event-associated data and rules to the CRM events, processing the data and rules of the CRM event by the event management system.

In one or more embodiments of the event management method, a line item of the event-associated data and rules includes time frame requirements of the required action in response to the CRM event. In another aspect of some embodiments, the event management method further comprises: mapping to what time period the required action in response to the event occurs, and any time remaining in the CRM event. In still another aspect of some embodiments, the event management method further comprises: generating a score, via an AI based commission matching system, for all commission item/CRM item relationships on a commission items list; evaluating, via the AI based commission matching system, all of the commission item/CRM item relationships for comparative strength with respect to a particular commission item; and implementing, via the AI based commission matching system, a commission item/CRM item relationships with greater comparative strength, while dropping commission item/CRM item relationships with lower comparative strength.

In yet another aspect of some embodiments of the event management method, the event-associated data and rules are commission time frames and amounts on the order for a good or service. Furthermore, in another aspect of some embodiments of the event management method, the required action in response to the event is a payment associated with the order for a good or service.

In other embodiments, a system for event management is disclosed. The system includes a memory that stores computer instructions and a processor. When executed, the computer instructions cause the system to: access CRM events, via the event management system, from a payment source data system; load event-associated data and rules via the event management system that correspond to the CRM events, wherein the event-associated data and rules designate required actions in response to the CRM events; match the event-associated data and rules to the CRM events; identify any errors involving discrepancies that exist between the CRM events that were expected and that have occurred, the matched event-associated data and rules corresponding to the CRM events that were expected and that have occurred, and the required actions in response to the CRM events that were expected and that have occurred; and initiate remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.

In some embodiments, the event management system is configured to populate an audit interface comparing expected required actions in response to the CRM events against actual performed required actions in response to the CRM events, after matching the event-associated data and rules to the CRM events. In another aspect of some embodiments, the event management system is configured to create a flag to initiate remedial actions to correct the identified errors, after identifying any errors involving discrepancies. In still another aspect of some embodiments, the event management system is configured to submit a remedial action request to a responsible payor system to resolve the error. In yet another aspect of some embodiments, the event management system is configured to process the data and rules of the CRM event, after matching the event-associated data and rules to the CRM events.

In one or more embodiments of the event management system, a line item of the event-associated data and rules includes time frame requirements of the required action in response to the CRM event. In another aspect of some embodiments, the event management system is configured to map a time period to which the required action in response to the event occurs, and any time remaining in the CRM event. In still another aspect of some embodiments, the event management system generates a score, via an AI based commission matching system, for all commission item/CRM item relationships on a commission items list; evaluates, via the AI based commission matching system, all of the commission item/CRM item relationships for comparative strength with respect to a particular commission item; and implements, via the AI based commission matching system, a commission item/CRM item relationships with greater comparative strength, while dropping commission item/CRM item relationships with lower comparative strength.

In yet another aspect of some embodiments of the event management system, the event-associated data and rules are commission time frames and amounts on the order for a good or service, and wherein required action in response to the event is a payment associated with the order for a good or service.

In still other embodiments, a system for event management is disclosed. The method includes: requesting information regarding CRM events, and event-associated data and rules that correspond to the CRM events, wherein the event-associated data and rules designate required actions in response to the CRM events; matching the event-associated data and rules to the CRM events; identifying any errors involving discrepancies that exist between the CRM events that were expected and that have occurred, the matched event-associated data and rules corresponding to the CRM events that were expected and that have occurred, and the required actions in response to the CRM events that were expected and that have occurred; and initiating remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.

The embodiments described in the present disclosure improve upon known data storage architectures, structures, processes, and techniques in a variety of different computerized technologies, such as operating systems, user interfaces, and social networks.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a system diagram of an Event Management System in association with a Customer Relationship Management Database, a plurality of users, a plurality of events, and a plurality of event-associated data and rules corresponding to the plurality of events;

FIG. 2 illustrates a workflow diagram of an event-associated data and rules matching procedure;

FIG. 3A illustrates a workflow diagram of a CRM event to an event-associated data and rules audit procedure;

FIG. 3B illustrates an event-associated data and rules forecasting workflow diagram;

FIG. 4 illustrates a screenshot of an event-associated data and rules diagram in the event management system by time period, payee, and supplier, in accordance with embodiments described herein;

FIG. 5A illustrates a screenshot of a mapping of File Type Mapping diagram in the event management system, in accordance with embodiments described herein;

FIG. 5B illustrates a screenshot of a mapping of a Target Fields Commissions Import diagram in the event management system, in accordance with embodiments described herein;

FIG. 6 illustrates a screenshot of CRM Events in the event management system, in accordance with embodiments described herein;

FIG. 7 illustrates a screenshot of CRM Events to matched event-associated data and rules in the event management system, in accordance with embodiments described herein;

FIG. 8 illustrates a logic diagram showing an event management method; and

FIG. 9 illustrates a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks and the mobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

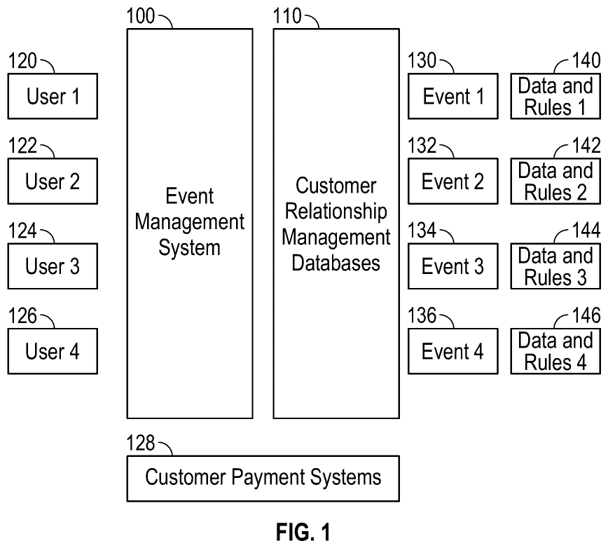

FIG. 1 illustrates a system diagram of an Event Management System 100 in association with a Customer Relationship Management database 110, a plurality of users 120, 122, 124, 126, a plurality of events 130, 132, 134, 136, and a plurality of event-associated data and rules 140, 142, 144, 146 corresponding to the plurality of events. In one or more embodiments, an Event Management System 100 with error identification and remediation through multiple interacting systems is disclosed. In one such embodiment, the Event Management System 100 is a secure, cloud-based SaaS product that connects to one or more Customer Relationship Management databases 110 to receive data from customer payment systems 128, for example, their sales commission payments. Notably, the Event Management System 100 is configured to identify errors involving discrepancies related to Events 130, 132, 134, 136, Event-associated data and rules 140, 142, 144, 146, and Required Actions in response to the Events, as well as to initiate error corrections related to these discrepancies. Notably, Customer Relationship Management databases 110 include Salesforce, HubSpot, Zoho, and the like.

In one example embodiment, the Event Management System 100 is used by technology sales agents (e.g., users 120, 122, 124, 126) to track deals and orders with companies, as well as the related commissions and payments. The companies pay the agents for these deals and orders using the customer payment systems 128. In such an embodiment, deals and orders are referred to as events 130, 132, 134, 136, the event-associated data and rules are referred to as commissions 140, 142, 144, 146, and the required actions in response to the events are payments. In this example, the technology sales agents sell products and services, such as internet services, video conferencing services, applications, security services, and the like. There will be commissions and other payment rules associated with the sales of these goods and services. Typically, the technology sales agents receive a commission for the technology that they recommend and sell to their clients. The commission likely involves rules, such as percentage of commission payments, length of commission payments, and timing of commission payments. In such an embodiment, the Event Management System 100 connects and tracks the user that made the deal or order (i.e., event) with the commission (data and related rules) associated with the deal or order, as well as the size of the deal, length of the deal, and the like.

In some embodiments, the Event-associated data and rules 140, 142, 144, 146 include different commissions at different rates company to company, item to item, service to service, and like. Additionally, a company may provide a first commission to a first agent for the sale of a service to an end-user, while the company may provide a different second commission to a second agent for an equivalent sale of the same service to another end-user. The second commission may be different than the first commission for numerous reasons, including seniority of the agents, past sales volume of the agents, exclusivity of one of the agents with the company, and the like.

These criteria all represent associated data and rules that must be uploaded into the Event Management System 100 so that it can accurately determine commissions, determine payment details, identify errors, and initiate remediation of the errors. The Event Management System 100 is also in communication with the Customer Relationship Management databases 110 to pull data regarding the deals and orders (i.e., events). The Event Management System 100 then matches the pulled data regarding the deals and orders 130, 132, 134, 136 to the event-associated data and rules 140, 142, 144, 146.

Significantly, the Event Management System 100 does not just track deals and commissions that are expected to be paid, but also whether such deals and commissions are actually paid. Thus, the Event Management System 100 identifies errors in the process, such failures to make payments, improper payment amounts, payments to the incorrect payees, early or otherwise improper termination of payments (e.g., failure to maintain commission connection to the user when customer upgrades the order within the framework of the original commission agreement), and the like. Additionally, the Event Management System 100 also initiates remediation of errors in the process that have been identified by the system. Furthermore, the Event Management System 100 provides auditing and analytics to assist in determining if there are any patterns or trends in the identified errors.

By identifying patterns or trends in the identified errors, the Event Management System 100 can initiate preventative actions or preemptive actions to circumvent errors before they occur. For example, the Event Management System 100 identifies that a specific payee always (or frequently) underpays (or pays in a delinquent time frame) for a certain type of deal or order. In this manner, the Event Management System 100 could initiate actions such as warning/reminding this specific payee to abide by the commission rules in a timely manner, require funds to be prepaid or held in trust escrow for the specific payee, or even initiate replacement of the specific payee with a competitor in extreme cases.

In some embodiments, the Event Management System 100 accesses information about events 130, 132, 134, 136 associated with users (e.g., agents) 120, 122, 124, 126 via a link to one or more Customer Relationship Management databases 110. In one embodiment, the Customer Relationship Management databases 110 (e.g., HubSpot, Salesforce, Zoho) are connected to the Event Management System 100 via REST API, which is a type of application program interface (API) that uses HTTP requests to access and use data. In other embodiments, other data transmission methods are utilized. The Event Management System 100 processes this event information pulled regarding deals (e.g., events) from the Customer Relationship Management system (CRM) for identifying and remediating errors. Data from the events include but are not limited to: Deal Name, Customer Name, Service Address, Supplier, Deal Status, Deal Monthly Recurring Charge (MRC), Order Date/Signature Date, Commissioning Account Number, and Payor.

In another aspect of some embodiments, the Event Management System 100 loads event rules 140, 142, 144, 146 and mappings to the events 130, 132, 134, 136, such as by loading commission statements. In some embodiments, each agent 120, 122, 124, 126 that uses the Event Management System 100 loads commission statements via an XCV file or an API Connection to their Technology Service Distributor (TSD) into the Event Management System 100. Import mappings may be created for each commission statement. In one such embodiment, the Import Mappings includes some or all of the following data points, if available: Supplier/Provider, Customer, Account number, Product, Order number, Quantity, Net Billed Amount, Gross Commission Amount, Gross Commission percentage, Invoice Date, Install Date, Start Date, End Date, Cancellation Date, BTN, Circuit ID, Term, Service Number, Location Description, Location Address, BAN, SIM, and IMEI.

In still another aspect of some embodiments, the Event Management System 100 performs error detection and remediation. One way in which error detection and remediation may be performed is by matching commissions that are expected to be paid (e.g., commissions on sold deals) against commissions that have actually been paid. For example, after the deals (e.g., events) are loaded into the Event Management System 100 and commission statements (e.g., event-associated data and rules) are loaded into the Event Management System 100, the commission matching process begins. Commission matching is the process in which a commission line item from a statement is matched to a deal in the Customer Relationship Management databases 110.

In various embodiments, the commission matching may be set in the Event Management System 100 in several different ways. In one embodiment, each payor/supplier combination is set to match the account number in the commission statement to the commissioning account number in the Customer Relationship Management databases 110. In other embodiments, payor/supplier combination is set to match based on Order number, Circuit ID, Address, Product, or any other unique Identifier. For example, in one embodiment, AT&T provides the Order number and circuit ID on their commission statement. The Event Management System 100 may be set to match based off the Order number. If that doesn't work, then the Event Management System 100 may use the circuit ID. This enables for matching to be performed automatically and without human interaction.

In still another embodiment, once there is a match made, the Event Management System 100 pushes the following information to the Customer Relationship Management databases 110. The pushed information includes: changes to the deal status due to commissioning from a closed/won state, adding the commissioning account number; adding the current customer billing amount; and adding the current customer commission amount. This pushing of information by the Event Management System 100 to the Customer Relationship Management databases 110 enables the client to perform more robust reporting within their CRM, and analyze what they sold versus what they were paid.

Reports that may be produced by the Event Management System 100 include: commissions by payor; commissions by supplier; commissions by referral agent; commissions by customer; spiff report; and deals audit report. For example, one report from the Event Management System 100 compares all the deals from the CRM against the matched commissions for those deals. This enables agents 120, 122, 124, 126 to quickly identify where they are not receiving proper payments.

Referring now to another aspect, the Event Management System 100 has several different types of licenses, including main user licenses and sales user licenses. Each different license provides different levels of access to the Event Management System 100. The main user license enables an agent to connect to a Customer Relationship Management database 110. Additionally, the main user license enables an agent to set up commissions and load commissions on the Event Management System 100. Further, the main user license allows an agent to enable other users. In contrast, a sales user license only enables an agent see reporting for their own commission statement, including any auditing reports for their deals.

In some embodiments, the Event Management System 100 includes still additional inventive features. In one such embodiment, the Event Management System 100 includes a calibration refresh function that pushes and pulls data from the Customer Relationship Management databases 110 to update data on command, instead of refreshing the data automatically throughout the day. In another aspect of some embodiments, the Event Management System 100 has the connection ability already established via an App in Customer Relationship Management databases 110. In still another aspect of some embodiments, the Event Management System 100 has API connections to Technology Service Distributors. In yet another embodiment, an API connection enables data to be pulled over from an agent's commission system into the Event Management System 100. Finally, in some embodiments, the Event Management System 100 pushes back any disputes that need to be made.

The Event Management System 100 provides several technological improvements such as enhanced data security, CRM integration, advanced reports and analytics, and streamlined payouts with error identification and remediation. Enhanced data security is provided by the hosting of data in a secure cloud-based environment. This ensures that private commissioning data is protected and not available to other agents or Technology Service Distributors. The Event Management System seamlessly integrates with multiple CRMs, channeling sales data into a centralized commissioning platform. Advanced reports and analytics enable users to evaluate forecasted versus actual revenue using interactive tables and charts, as well as streamlining the reconciliation of lapsed payments from providers. Finally, streamlined payouts are facilitated to sales agents based on their closed revenue, and sales agents are granted access to the platform for seamless viewing of their expected payouts.

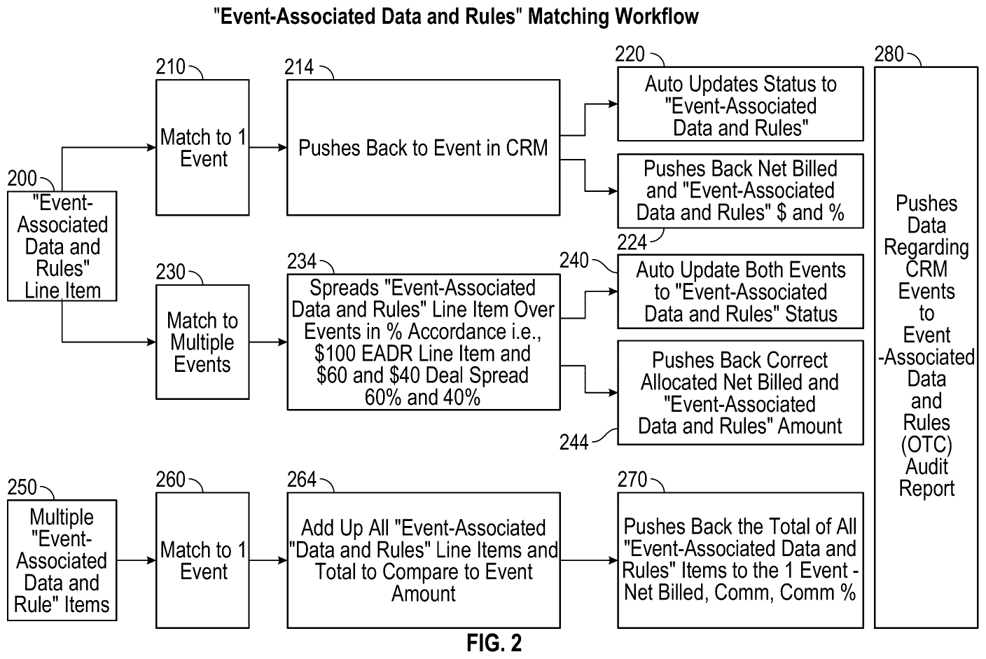

FIG. 2 illustrates a workflow diagram of an event-associated data and rules (i.e., Commission) matching procedure. Operation 200 of the commission matching procedure shows a single commission line item. Operation 210 of the commission matching procedure shows a match to one deal. Operation 214 of the commission matching procedure shows the Event Management System 100 pushing back to an event in Customer Relationship Management database 110. Operation 220 of the commission matching procedure shows the Event Management System 100 auto updating the status of a commission (e.g., event-associated data and rules). Operation 224 of the commission matching procedure shows the Event Management System 100 pushing back net billed and commission (e.g., event-associated data and rules) payments and percentages.

Continuing in FIG. 2, Operation 230 of the commission matching procedure shows a match to multiple deals. Operation 234 of the commission matching procedure shows the Event Management System 100 spreading the commission line item over multiple deals in percentage accordance (e.g., $100 commission line item—$60 and $40deal spread 60% and 40%). Operation 240 of the commission matching procedure shows the Event Management System 100 auto updating both deals to commissioning (e.g., event-associated data and rules). Operation 244 of the commission matching procedure shows the Event Management System 100 pushing back correct allocated net billed and commission amount.

Further continuing in FIG. 2, Operation 250 of the commission matching procedure shows multiple commission line items. Operation 260 of the commission matching procedure shows a match to one deal. Operation 264 of the commission matching procedure shows the Event Management System 100 adding up all commission line items and total to compare to deal amount. Operation 270 of the commission matching procedure shows the Event Management System 100 pushing back the total of all commission (e.g., event-associated data and rules) items to the single deal—net billed, commission payment, and commission percentage. Finally, at operation 280 of the commission matching procedure, data is pushed regarding CRM events to commission (e.g., event-associated data and rules) Audit Report.

### AI Based Commission Matching

In another aspect of some embodiments, the Event Management System incorporates an AI based Commission matching system instead of traditional commission matching techniques. The AI based Commission matching system is executed by gathering all of the Commission Items for a client, for one period, and a Supplier, and then comparing all of these Commission Items to all CRM Item Details for matches. All Commission Item Field of type Commission Matching is then compared with values in the CRM Item Details item, deal, and company JSON fields for any matches.

If the AI based Commission matching system finds a full match with a field value, then the system provides a score of 100, and the field in which the match was found is flagged as a match and the Line Item ID is tracked. The AI based Commission matching system then repeats this process for all Commission Items until a score is generated for all Commission Item/CRM Item Relationships.

Next, the AI based Commission matching system evaluates the Commission Items list to see if there are any Commission Item/CRM Item Relationships that are stronger than others for a particular Commission Item. If there are any stronger and weaker Commission Item/CRM Item Relationships, then the AI based Commission matching system drops the weaker relationships and only keep the strongest relationships. In some embodiments, if there are multiple Commission Item/CRM Item Relationships with the same score, then the AI based Commission matching system keeps all of the Commission Item/CRM Item Relationships. Once this filtering of Commission Item/CRM Item Relationships is complete, the AI based Commission matching system writes them to CRM Commission Matches.

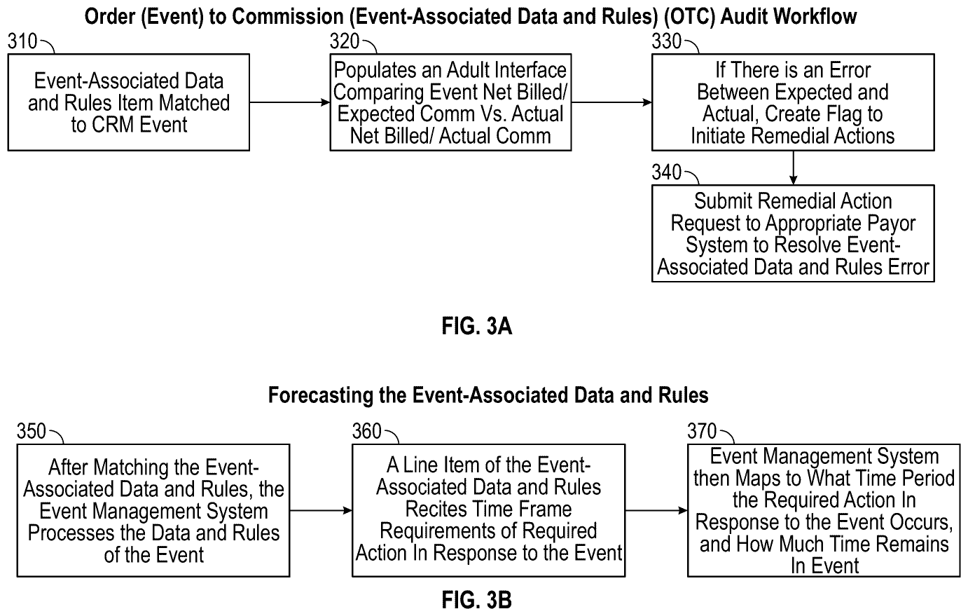

FIG. 3A illustrates a workflow diagram of a CRM event (i.e., Order) to event-associated data and rules (i.e., Commission) audit procedure. At operation 310 of audit procedure, the event-associated data and rules items are matched to CRM events. At operation 320 of audit procedure, the Event Management System 100 populates an audit interface by comparing “event net billed” and “expected commissions” verses “actual net billed” and actual “commissions.” At operation 330 of audit procedure, the Event Management System 100 determines if there is an error between expected billings and commissions, and actual billings and commissions. If there are any such errors, the Event Management System 100 creates a flag to initiate remedial actions. At operation 340 of audit procedure, the Event Management System 100 submits a remedial action request to the appropriate payor system to resolve any determined event-associated data and rules errors.

FIG. 3B illustrates an event-associated data and rules (i.e., commissions) forecasting workflow diagram. At operation 350 of the commissions forecasting workflow, the Event Management System 100 processes the data and rules of the event after matching the event-associated data and rules to the corresponding events. At operation 360 of the commissions forecasting workflow, the Event Management System 100 reads a line item of the commission (e.g., event-associated data and rules) that recites time frame requirements of payment (e.g., required action in response to the event). The time frame may be recited in months and/or years. Finally, at operation 370 of the commissions forecasting workflow, the Event Management System 100 maps to what time period the payment (e.g., required action in response to the event) occurs, and how much time remains in the deal (e.g., event).

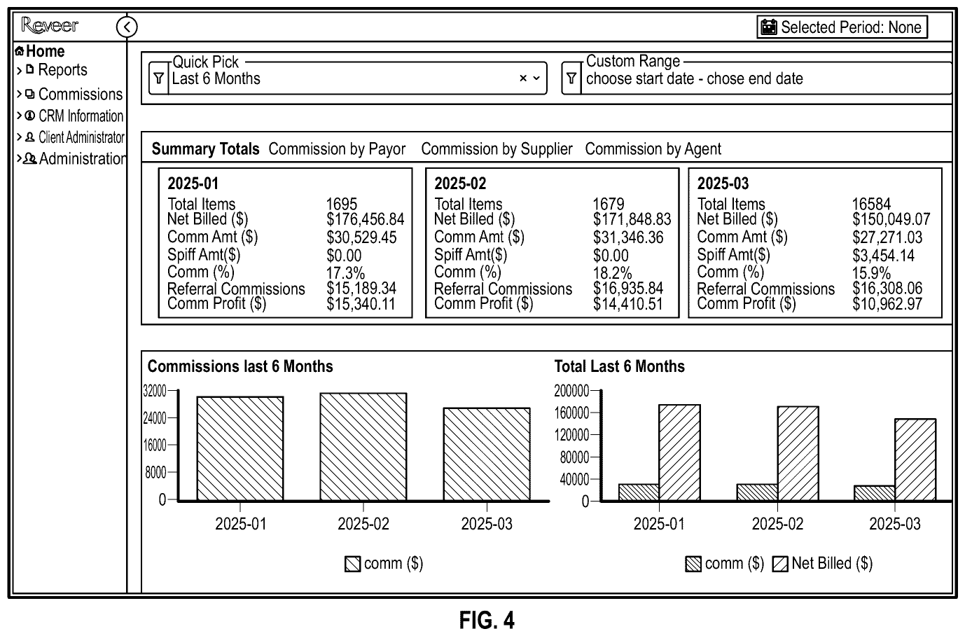

FIG. 4 illustrates a screenshot of a commissions diagram in the Event Management System by time period, payor, and supplier, and agent. Specifically, the screenshot in FIG. 4 shows a chart of commissions by payor, commissions by supplier, commissions by agent, commissions over the last 6 months, and totals over the last 6 months including net billed amounts. Additionally, FIG. 4 shows a Quick Pick filter with “Last 6 Months” selected in a dropdown menu, as well as a Custom Range filter with a “Choose start date-chose end state” selection.

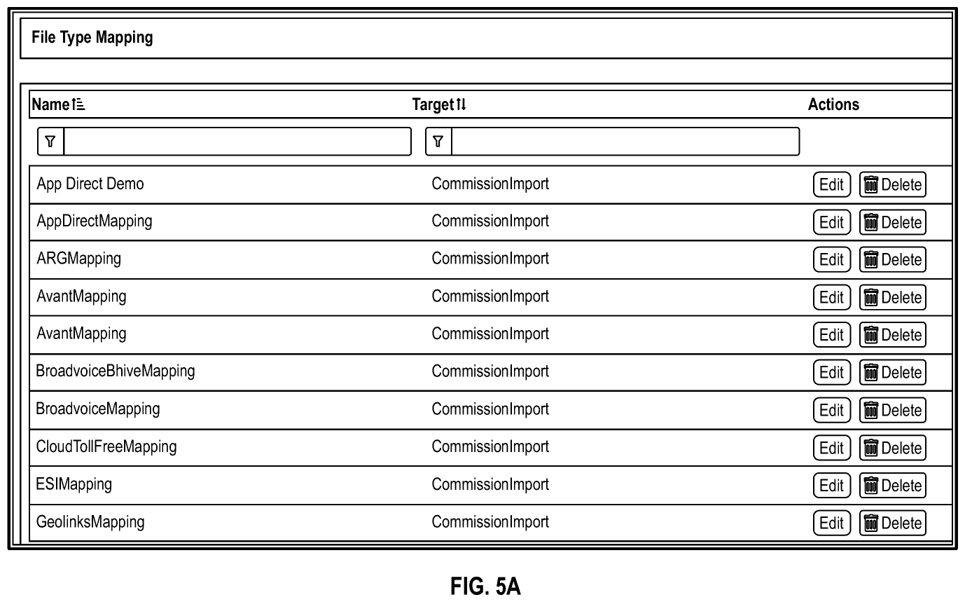

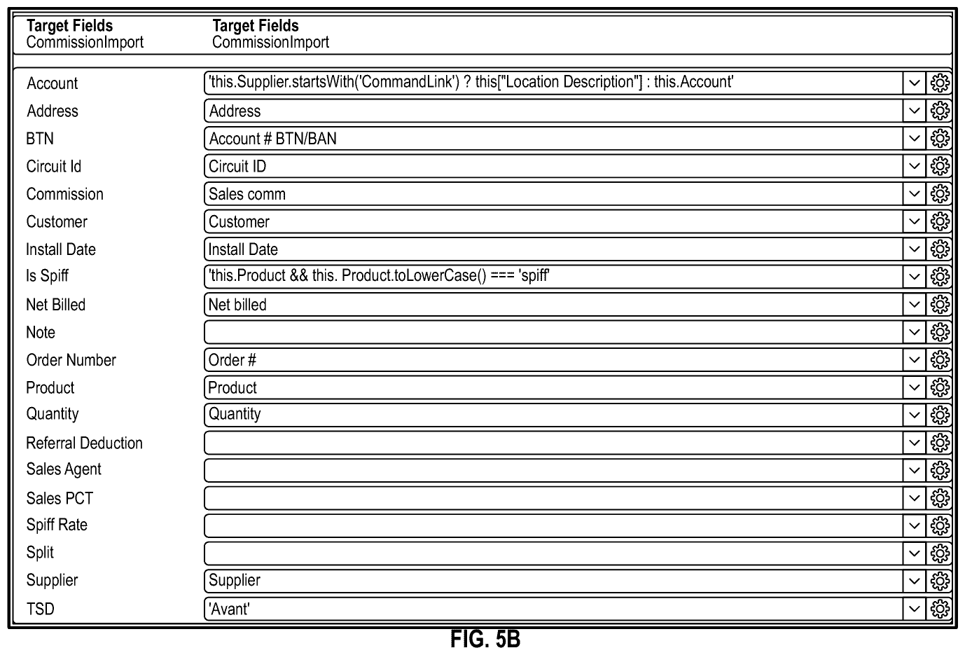

FIG. 5A illustrates a screenshot of a File Type Mapping diagram in the Event Management System. One section of the Mappings includes a list of Names, Targets, and Actions, as well as filtering capabilities. In some embodiments, the lists may be sorted by Name and Target. Edit and delete functionality is also provided for each entry.

FIG. 5B illustrates a screenshot of a Target Fields Commissions Import diagram in the Event Management System. Numerous fields and field headings are provided that include: Account, Address, BTN, Circuit ID, Commission, Customer, Install Data, Is Spiff, Net Billed, Note, Order Number, Product, Quality, Referral Deduction, Sales Agent, Sales PCT, Spiff Rate, Split, Supplier, and TSD.

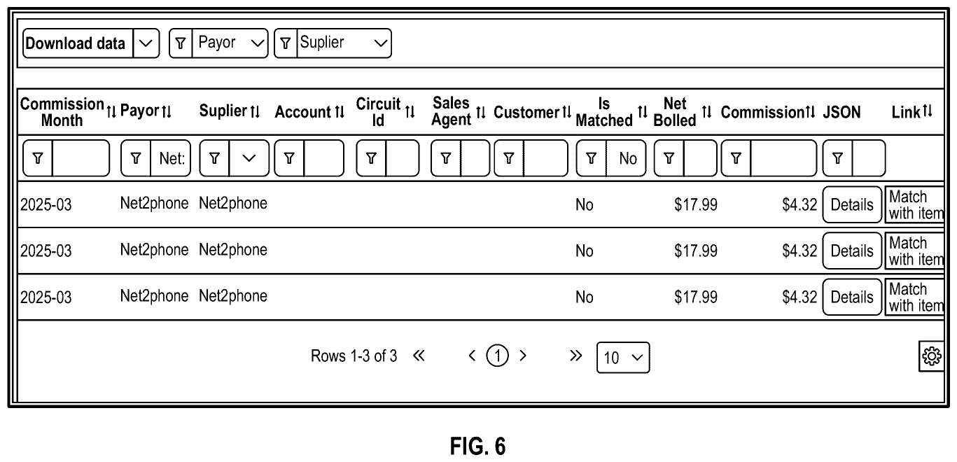

FIG. 6 illustrates a screenshot of a client dashboard that includes filters and dropdown menus for Download data, Payor, and Supplier in the Event Management System. Numerous fields and field headings are provided that include: Commission Month, Payor, Supplier, Account, Circuit ID, Sales Agent, Customer, Is Matched, Net Bolled, Commission, and JSON.

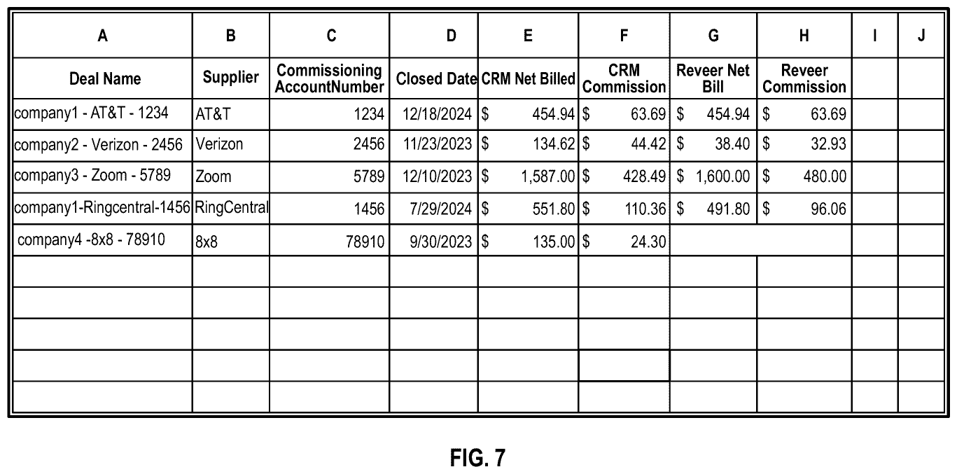

FIG. 7 illustrates a screenshot of a deals audit report of all commissioned items. Specifically, FIG. 7 shows a list of deals (e.g., CRM Events) to matched commission items in the Event Management System. The deals list includes information such as: Deal Name, Supplier, Commissioning Account Number, Closed Date, CRM Net Billes CRM Commission, Reveer Net Bill, and Reveer Net Commission.

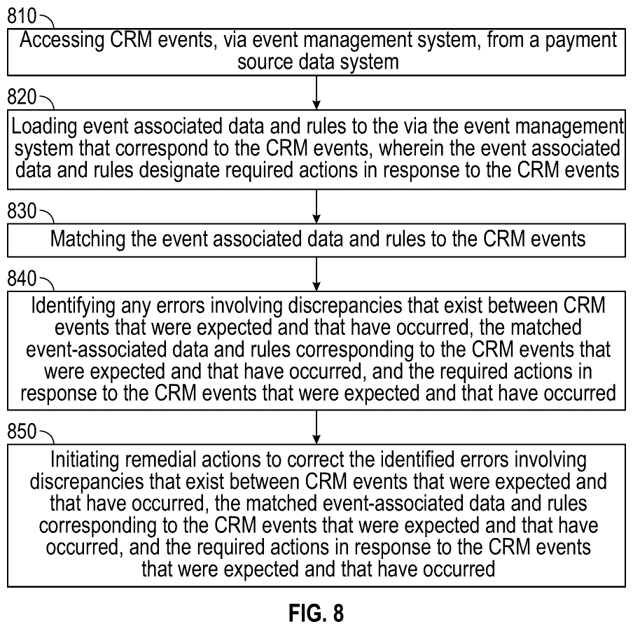

FIG. 8 is a logic diagram showing a method for event management, error identification, and error remediation. As shown in FIG. 8, at operation 810, the method includes loading event-associated data and rules via the event management system that correspond to the CRM events, wherein the event-associated data and rules designate required actions in response to the CRM events. At operation 820, the method includes accessing CRM events, via the event management system, from a payment source data system. At operation 830, the method includes matching the event-associated data and rules to the CRM events. At operation 840, the method includes identifying any errors involving discrepancies that exist between CRM events that were expected and that have occurred, the matched event-associated data and rules corresponding to the CRM events that were expected and that have occurred, and the required actions in response to the CRM events that were expected and that have occurred. At operation 850, the method includes initiating remedial actions to correct the identified errors involving discrepancies that exist between CRM events that were expected and that have occurred, the matched event-associated data and rules corresponding to the CRM events that were expected and that have occurred, and the required actions in response to the CRM events that were expected and that have occurred.

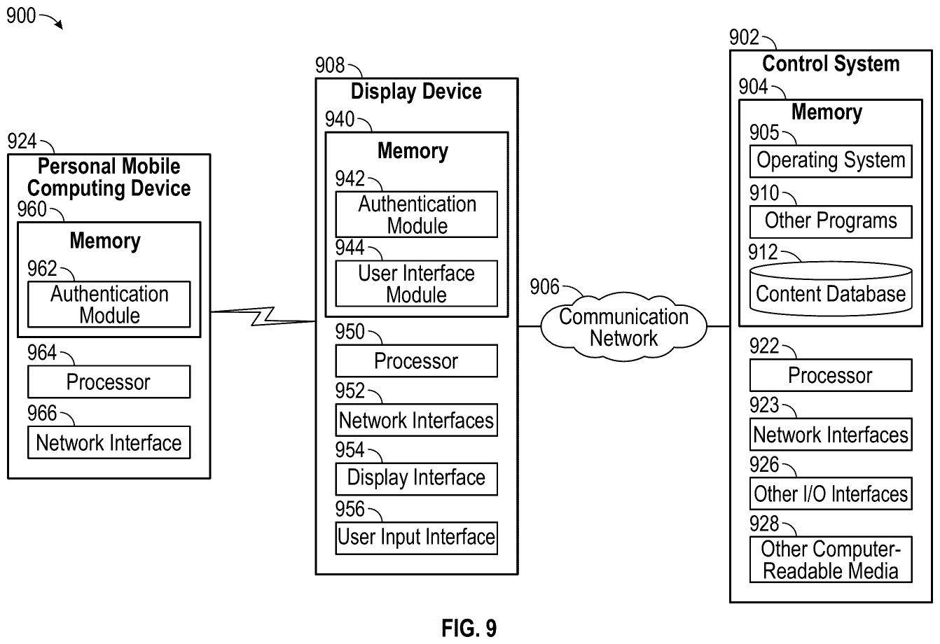

FIG. 9 shows a system diagram that describes one implementation of computing systems for implementing embodiments described herein. System 900 includes control system 902, one or more display devices 908, and one or more personal mobile computing devices 924. As described herein, the control system 902 is a computing device that can perform functionality described herein for implementing an operating system that provides a user interface for storing content. One or more special purpose computing systems may be used to implement the control system 902. Accordingly, various embodiments described herein may be implemented in software, hardware, firmware, or in some combination thereof. The control system 902 includes memory 904, one or more processors 922, network interface 923, other input/output (I/O) interfaces 926, and other computer-readable media 928. In some embodiments, the control system 902 may be implemented by cloud computing resources.

Processor 922 includes one or more processing devices that execute computer instructions to perform operations (e.g., actions), including at least some embodiments described herein. In various embodiments, the processor 922 may include one or more central processing units (“CPU”), programmable logic, or other processing circuitry.

Memory 904 may include one or more various types of non-volatile and/or volatile storage technologies. Examples of memory 904 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 904 may be utilized to store information, including computer-readable instructions that are utilized by processor 922 to perform actions, including at least some embodiments described herein.

Memory 904 may have stored thereon operating system 905. The operating system 905 authenticates users of personal mobile computing devices 924 via display devices 908 and provides a user interface for storing and accessing content, as described herein. Memory 904 may include a content database 912 for storing content in accordance with the user interface. Memory 904 may also store other programs 910. The other programs 910 may include other operating systems, user applications, or other computer programs that are accessible to the personal mobile computing device 924 via the display device 908.

Network interface 923 is configured to communicate with other computing devices, such as the display devices 908, via a communication network 906. Network interface 923 includes transmitters and receivers (not illustrated) to send and receive data associated with the user interface described herein.

Other I/O interfaces 926 may include interfaces for various other input or output devices, such as audio interfaces, other video interfaces, USB interfaces, physical buttons, keyboards, haptic interfaces, tactile interfaces, or the like. Other computer-readable media 928 may include other types of stationary or removable computer-readable media, such as removable flash drives, external hard drives, or the like.

The display devices 908 are computing devices that are remote from the control system 902. In some embodiments, the display devices 908 may include one or more computing devices and display devices. The display devices 908 coordinate authentication between the personal mobile computing devices 924 and the control system 902. The display devices 908 receive input from the users of the personal mobile computing device 924 and provide the input to the control system 902. The display devices 908 receive the graphical user interfaces for the user interface to be presented to the users of the personal mobile computing devices 924.

One or more special-purpose computing systems may be used to implement the display devices 908. Accordingly, various embodiments described herein may be implemented in software, hardware, firmware, or in some combination thereof. The display devices 908 include memory 940, one or more processors 950, network interface 952, display interface 954, and user input interface 956. The memory 940, processor 950, and network interface 952 may be similar to, include similar components, or incorporate embodiments of memory 904, processor 922, and network interface 923 of control system 902, respectively. Thus, processor 950 includes one or more processing devices that execute computer instructions to perform operations (e.g., actions), including at least some embodiments described herein. In various embodiments, the processor 950 may include one or more CPUs, programmable logic, or other processing circuitry. The network interfaces 952 is also configured to communicate with the personal mobile computing devices 924, such as via Bluetooth or other short-range communication protocol or technology.

Memory 940 may include one or more various types of non-volatile and/or volatile storage technologies. Memory 940 may be utilized to store information, including computer-readable instructions that are utilized by processor 950 to perform actions, including at least some embodiments described herein. Memory 940 may store various modules or programs, including authentication module 942 and user interface module 944. The authentication module 942 may perform actions that coordinate the authentication between the personal mobile computing devices 924 and the control system 902. The user interface module 944 receives graphical user interface data from the control system 902 for display or presentation, via the display interface 954, to the user of the personal mobile computing devices 924. The user interface module 944 also receives user input via the user input interface 956 and provides that input back to the control system 902. In various embodiments, one or more capacitive, radar, infrared, LIDAR, or other type of gesture capturing sensors may be used to receive the user input. In some other embodiments, the user interface module 944 may receive user inputs via other input mechanisms, such as a mouse, stylus, voice-recognition, or other input sensors. Memory 940 may also store other programs.

The personal mobile computing devices 924 are computing devices that are remote from the display devices 908 and the control system 902. When a personal mobile computing device 924 is within a threshold range of the display device 908 or when a user of the personal mobile computing device 924 activates authentication, the personal mobile computing device 924 provides authentication data or information to the display device 908 for forwarding to the control system 902. In various embodiments, the personal mobile computing device 924 is separate from the display device 908, such that a user can walk up to a display device 908 with the personal mobile computing device 924 to initiate the process described herein to have the display device 908 present the user interface received from the control system 902. The user can then provide input to the display device 908, such as with hand gestures or arm movement, to manipulate the user interface and select content for display.

One or more special-purpose computing systems may be used to implement the personal mobile computing devices 924. Accordingly, various embodiments described herein may be implemented in software, hardware, firmware, or in some combination thereof.

The personal mobile computing devices 924 include memory 960, one or more processors 964, and a network interface 966. The memory 960, processor 964, and network interface 966 may be similar to, include similar components, or incorporate embodiments of memory 940, processor 950, and network interfaces 952 of display devices 908, respectively. Thus, processor 964 includes one or more processing devices that execute computer instructions to perform operations (e.g., actions), including at least some embodiments described herein. In various embodiments, the processor 964 may include one or more CPUs, programmable logic, or other processing circuitry. The network interface 966 is configured to communicate with the display devices 908, but not with the control system 902.

Memory 960 may include one or more various types of non-volatile and/or volatile storage technologies. Memory 960 may be utilized to store information, including computer-readable instructions that are utilized by processor 964 to perform actions, including at least some embodiments described herein. Memory 960 may store various modules or programs, including authentication module 962. The authentication module 962 may perform actions to communicate authentication information to a display device 908 when within a threshold distance from the display device or when activated by a user.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A method for identifying and remediating errors involving discrepancies related to Customer Relationship Management (CRM) events, event-associated data and rules, and required actions in response to the events, the method comprising:
accessing CRM events, via an event management system, from a payment source data system;
loading event-associated data and rules via the event management system that correspond to the CRM events, wherein the event-associated data and rules designate required actions in response to the CRM events;
matching the event-associated data and rules to the CRM events;
identifying any errors involving discrepancies that exist between the CRM events that were expected and that have occurred, the matched event-associated data and rules corresponding to the CRM events that were expected and that have occurred, and the required actions in response to the CRM events that were expected and that have occurred; and
initiating remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.

2. The method of claim 1, further comprising: after matching the event-associated data and rules to the CRM events, populating an audit interface comparing expected required actions in response to the CRM events against actual performed required actions in response to the CRM events.

3. The method of claim 1, further comprising: after identifying any errors involving discrepancies, creating a flag to initiate remedial actions to correct the identified errors.

4. The method of claim 1, further comprising: submitting a remedial action request to a responsible payor system to resolve the error.

5. The method of claim 1, further comprising:
after matching the event-associated data and rules to the CRM events, processing the data and rules of the CRM event by the event management system.

6. The method of claim 1, wherein a line item of the event-associated data and rules includes time frame requirements of the required action in response to the CRM event.

7. The method of claim 1, further comprising:
mapping to what time period the required action in response to the event occurs, and any time remaining in the CRM event.

8. The method of claim 1, further comprising:
generating a score, via an (Artificial Intelligence) AI based commission matching system, for all commission item/CRM item relationships on a commission items list;
evaluating, via the AI based commission matching system, all of the commission item/CRM item relationships for comparative strength with respect to a particular commission item; and
implementing, via the AI based commission matching system, a commission item/CRM item relationships with greater comparative strength, while dropping commission item/CRM item relationships with lower comparative strength.

9. The method of claim 8, wherein the event-associated data and rules are commission time frames and amounts on the order for a good or service.

10. The method of claim 8, wherein the required action in response to the event is a payment associated with the order for a good or service.

11. A system for event management, the system comprising:
a memory that stores computer instructions and a processor that, when executing the computer instructions, causes the system to:
access CRM events, via the event management system, from a payment source data system;
load event-associated data and rules via the event management system that correspond to the CRM events, wherein the event-associated data and rules designate required actions in response to the CRM events;
match the event-associated data and rules to the CRM events;
identify any errors involving discrepancies that exist between the CRM events that were expected and that have occurred, the matched event-associated data and rules corresponding to the CRM events that were expected and that have occurred, and the required actions in response to the CRM events that were expected and that have occurred; and
initiate remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.

12. The system of claim 11, wherein the event management system is configured to populate an audit interface comparing expected required actions in response to the CRM events against actual performed required actions in response to the CRM events, after matching the event-associated data and rules to the CRM events.

13. The system of claim 11, wherein the event management system is configured to create a flag to initiate remedial actions to correct the identified errors, after identifying any errors involving discrepancies.

14. The system of claim 11, wherein the event management system is configured to submit a remedial action request to a responsible payor system to resolve the error.

15. The system of claim 11, wherein the event management system is configured to process the data and rules of the CRM event, after matching the event-associated data and rules to the CRM events.

16. The system of claim 11, wherein a line item of the event-associated data and rules includes time frame requirements of the required action in response to the CRM event.

17. The system of claim 11, wherein the event management system is configured to map a time period to which the required action in response to the event occurs, and any time remaining in the CRM event.

18. The system of claim 11, wherein the event management system is configured to:
generate a score, via an (Artificial Intelligence) AI based commission matching system, for all commission item/CRM item relationships on a commission items list;
evaluate, via the AI based commission matching system, all of the commission item/CRM item relationships for comparative strength with respect to a particular commission item; and
implement, via the AI based commission matching system, a commission item/CRM item relationships with greater comparative strength, while dropping commission item/CRM item relationships with lower comparative strength.

19. The system of claim 18, wherein the event-associated data and rules are commission time frames and amounts on the order for a good or service, and wherein required action in response to the event is a payment associated with the order for a good or service.

20. A method for event management, the method comprising:
requesting information regarding CRM events, and event-associated data and rules that correspond to the CRM events, wherein the event-associated data and rules designate required actions in response to the CRM events;
matching the event-associated data and rules to the CRM events;
identifying any errors involving discrepancies that exist between the CRM events that were expected and that have occurred, the matched event-associated data and rules corresponding to the CRM events that were expected and that have occurred, and the required actions in response to the CRM events that were expected and that have occurred; and
initiating remedial actions to correct the identified errors involving discrepancies that exist between the CRM events that were expected and that have occurred, the matched event-associated data and rules corresponding to the CRM events that were expected and that have occurred, and the required actions in response to the CRM events that were expected and that have occurred.
